(19) United States
(12) Patent Application Publication
(10) Pub. No.: US 2026/0056751 A1
(43) Pub. Date: Feb. 26, 2026

(54) SYSTEM AND METHOD FOR INFRASTRUCTURE-SUPPORTED ASSISTANCE OF A MOTOR VEHICLE

(71) Applicant: Robert Bosch GmbH, Stuttgart (DE)

(72) Inventors: Patrick Haag, Stuttgart (DE); Roland Schmid, Herrenberg (DE)

(21) Appl. No.: 19/294,643

(22) Filed: Aug. 8, 2025

(30) Foreign Application Priority Data
Aug. 22, 2024 (DE) 10 2024 208 010.1

(51) Int. Cl. G06F 9/445; G05D 1/227; G05D 109/10; G05D 111/30

(52) U.S. Cl. CPC G06F 9/445; G05D 1/227; G05D 2109/10; G05D 2111/30

(57) ABSTRACT

A system for infrastructure-supported assistance of a motor vehicle. The system includes: an RVO system configured to ascertain infrastructure assistance data in order to assist the motor vehicle in an infrastructure-supported manner during at least partially automated driving; an interface module, wherein the interface module has an input configured to receive the ascertained infrastructure assistance data, wherein the interface module is programmatically configured to execute one or more computer programs in order to process the received infrastructure assistance data in order to obtain a processing result, wherein the interface module has an output configured to output the processing result; and an air interface configured to transmit the output processing result to the motor vehicle.

A method for infrastructure-supported assistance of a motor vehicle, a computer program, and a machine-readable storage medium are also described.

### CROSS REFERENCE

The present application claims the benefit under 35 U.S.C. § 119 of Germany Patent Application No. DE 10 2024 208 010.1 filed on Aug. 22, 2024, which is expressly incorporated herein by reference in its entirety.

### FIELD

The present invention relates to a system and a method for infrastructure-supported assistance of a motor vehicle, to a computer program, and to a machine-readable storage medium.

### BACKGROUND INFORMATION

Automated Valet Parking (AVP) or Automated Vehicle Maneuvering (AVM-P) is a technology with which motor vehicles navigate through parking garages, motor vehicle factories, or logistics areas without a driver. The installed infrastructure (remote vehicle operation, RVO, according to ISO-23374) monitors the surroundings of the motor vehicle and controls it safely, without collisions and with sufficient distance from other road users.

In order for the motor vehicle to be controlled by the RVO, a communication connection is established between the motor vehicle and the RVO. Both the motor vehicle and the RVO are developed according to the same interface specification in order to be able to exchange messages and correctly interpret their content.

Changes to the specification, such as the format of the messages or the interpretation of the content, usually require an update of the software in both the RVO and the motor vehicle.

RVOs can generally be updated more quickly, more frequently, and more cost-effectively than motor vehicles since the number of RVOs in parking garages or factories is much smaller than the number of motor vehicles and the approval processes are simpler. In addition, not every vehicle can be updated over-the-air (OTA), which makes an update in a repair shop necessary.

For example, an interface specification may not always be 100% unambiguous and may be misinterpreted by the developer of an RVO or of a motor vehicle. This may often not become apparent in detail until a very late stage of development of the motor vehicle, or even after approval and start of production.

In general, the developers of RVOs and motor vehicles are different people or companies.

### SUMMARY

An object of the present invention is to provide a concept for infrastructure-supported assistance of a motor vehicle.

This object may be achieved by means of the present invention. Advantageous example embodiments of the present invention are disclosed herein.

According to a first aspect of the present invention, a system for infrastructure-supported assistance of a motor vehicle is provided. According to an example embodiment of the present invention, the system comprises:
an RVO system configured to ascertain infrastructure assistance data in order to assist the motor vehicle in an infrastructure-supported manner during at least partially automated driving, an interface module,
wherein the interface module has an input configured to receive the ascertained infrastructure assistance data,
wherein the interface module is programmatically configured to execute one or more computer programs in order to process the received infrastructure assistance data in order to obtain a processing result,
wherein the interface module has an output configured to output the processing result, and
an air interface configured to transmit the output processing result to the motor vehicle.

According to a second aspect of the present invention, a method for infrastructure-supported assistance of a motor vehicle using the system according to the first aspect is provided. According to an example embodiment of the present invention, the method comprises the following steps:
ascertaining infrastructure assistance data in order to assist the motor vehicle in an infrastructure-supported manner during at least partially automated driving, by the RVO system, receiving the ascertained infrastructure assistance data through the input of the interface module,
executing one or more computer programs in order to process the received infrastructure assistance data in order to obtain a processing result, by the interface module,
outputting the processing result through the output of the interface module,
transmitting the output processing result to the motor vehicle through the air interface.

According to a third aspect of the present invention, a computer program is provided, comprising commands that, when the computer program is executed by a computer, for example by the system according to the first aspect, cause said computer to perform a method according to the second aspect.

According to a fourth aspect of the present invention, a machine-readable storage medium is provided, on which the computer program according to the third aspect is stored.

The present invention is based on and includes the finding that the above object may be achieved by providing an interface module which processes the infrastructure assistance data ascertained by the RVO system, in order to obtain a processing result. The processing result is output by the interface module and transmitted to the motor vehicle via an air interface.

According to the concept described here, it is thus provided that the infrastructure assistance data ascertained by the RVO system are not transmitted to the motor vehicle through the air interface, but rather that the processing result is transmitted to the motor vehicle through the air interface.

This, for example, results in the technical advantage that, after they are ascertained, the ascertained infrastructure assistance data can be further processed, if necessary. For example, certain calculations or conversions can thus be outsourced to the infrastructure, in this case to the interface module. This may be necessary, for example, since a motor vehicle only has limited computing capacities available to carry out these calculations and conversions.

If, for example, a motor vehicle type does not interpret or implement messages comprising infrastructure assistance data of the RVO system, in accordance with the interface specification, a motor vehicle manufacturer can implement a solution or workaround within the interface module and thus, for example, within the RVO system, which may avoid more complex and expensive updates to the motor vehicle.

Furthermore, the computer program(s) that the interface module is to execute in order to process the received infrastructure assistance data can be provided as a so-called black box. For example, an OEM can thus supply the computer program(s) as a black box in order to avoid having to disclose the functionality or proprietary interface content to the operator of the RVO system or to other third parties.

For example, motor vehicles with proprietary interfaces can thus also be assisted in an infrastructure-supported manner. In the present case, the communication between the RVO system and the motor vehicle is handled by the interface module, which, for example, processes the infrastructure assistance data in such a way that they can be processed or understood by the motor vehicle. Reasons for a proprietary interface may, for example, as explained above, be limited computing capacities in the motor vehicle, as a result of which certain calculations or conversions, for example, have to be outsourced to the infrastructure.

The interface module according to the present invention, as described here, in particular advantageously simplifies implementation and approval and thus shifts, for example, knowledge about the proprietary interface and implementation effort from a developer of the RVO system to the motor vehicle manufacturer.

The features described here thus provide a way to give every motor vehicle manufacturer in the RVO system the opportunity to offer a motor-vehicle-specific software component to the motor vehicle at the air interface. These software components, i.e., the computer programs, are processed by the interface module within the infrastructure and thus run in particular in the context of the RVO system.

This can, for example, avoid the need for motor vehicles to be updated, for example, over the air due to a necessary update or, if an over-the-air update is not possible, for example, for them to be updated in a repair shop.

For example, this advantageously makes it possible to enable, even after approval of the motor vehicle, interface-compliant communication between the RVO system and the motor vehicle via appropriate computer programs executed by the interface module.

This in particular results in the technical advantage that the motor vehicle can be assisted efficiently in an infrastructure-supported manner.

This therefore results in the technical advantage that a concept for efficient infrastructure-supported assistance of a motor vehicle is provided.

The abbreviation RVO stands for “remote vehicle operation.” An RVO within the meaning of the description is, for example, an RVO according to ISO-23374, i.e., it meets the corresponding specifications according to ISO-23374, for example.

The abbreviation OEM stands for “original equipment manufacturer.”

An OEM within the meaning of the description is, for example, a motor vehicle OEM. A motor vehicle OEM is, for example, an OEM of the motor vehicle that is to be assisted in an infrastructure-supported manner.

The features described here can be used, for example, in the context of Automated Valet Parking (AVP) or in the context of AVM. AVM stands for “Automated Vehicle Marshalling.”

The motor vehicle is thus supported, for example, during at least partially automated driving, or the motor vehicle is assisted during at least partially automated driving.

The terms “assist” and “support” can be used synonymously. The concept described here can, for example, be used in one or more of the following use cases: Self-Navigating Automotive Production (SNAP) for controlling vehicles on the production lines, Automated Plant Marshalling (APM), Automated Factory Parking (AFP) or Automated Factory Marshalling (AFM) for maneuvering already assembled vehicles in the factory, Automated Valet Charging (AVC) and Automated Valet Parking (AVP) for maneuvering vehicles in parking facilities. In Self-Navigating Automotive Production or Automated Factory Marshalling or APM, a motor vehicle is guided by an infrastructure from the assembly line to further test stations or to a parking lot during or after the production of the motor vehicle. With Automated Valet Charging, a motor vehicle is assisted by the infrastructure to a free charging space.

APM can also be referred to as AVM-P. “P” stands for “plant.”

Since the interface module has an adapter function between the RVO system and the motor vehicle, the interface module can also be referred to as an interface adapter or an adapter, for example.

The interface module is, for example, a software module or a hardware module. For example, the interface module is implemented as a combined hardware module/software module.

This therefore means that the interface module is implemented, for example, as software or as hardware or as software/hardware.

In one example embodiment of the system of the present invention, it is provided that the interface module is implemented within the RVO system.

This, for example, results in the technical advantage that the interface module is implemented efficiently.

One advantage of an implementation within the RVO system is, for example, lower latencies in the transmission of the data from the RVO core system and the interface module. In principle, the interface module can of course also be located between the RVO and the air interface, for example.

One advantage, for example, is that the OEM has a black box (interface module) in the RVO, in which black box the OEM can carry out error corrections and optimizations quickly and in an encapsulated manner (without involving third parties).

The processing result comprises, for example, processed infrastructure assistance data.

Processing comprises, for example, converting curvatures to steering angles.

Part of a control loop can, for example, be moved from the motor vehicle to the interface module. Processing then comprises, for example, converting remaining distances and velocities into accelerations or motor torques.

In one example embodiment of the system of the present invention, it is provided that the interface module is programmatically configured to execute a program library as a computer program.

A library usually offers several functions that the RVO can call in its own cycle and the result of which the RVO can use directly without delay after the function has been executed. For example, one function can be provided for each message that is to be transmitted to the motor vehicle.

A separate program/process usually runs at its own clock speed, which requires additional synchronization and data transmission.

However, a separate program also offers advantages, e.g., it can be more secure and stable because a program executed outside the interface module by an RVO component and a program executed inside the interface module each use a separate memory so that an error in the interface module would not lead to a crash of the RVO component.

In one example embodiment of the system of the present invention, it is provided that the RVO system has an RVO core configured to ascertain and output the infrastructure assistance data, wherein the input of the interface module is configured to receive the infrastructure assistance data output by the RVO core.

This results in the technical advantage, for example, that the entity (RVO core) that ascertains the infrastructure assistance data is implemented separately from the entity (interface module) that further processes the infrastructure assistance data for the motor vehicle.

For example, it is provided that the RVO system comprises the RVO core, with the interface module being implemented within the RVO system but separately from the RVO core. In other words, it is provided, for example, that the interface module is implemented separately from the RVO core.

In one example embodiment of the system of the present invention, the system comprises a communication interface configured to receive one or more computer programs from a motor vehicle OEM, wherein the input of the interface module is configured to receive the one or more computer programs of the motor vehicle OEM, wherein the interface module is programmatically configured to execute the computer program(s) of the motor vehicle OEM as computer program(s).

This results in the technical advantage, for example, that a motor vehicle OEM can efficiently execute one or more computer programs by the interface module in order to process the received infrastructure assistance data in order to obtain a processing result, which is transmitted to the motor vehicle through the air interface.

System features of the present invention result analogously from corresponding method features of the present invention, and vice versa. This therefore means, in particular, that technical functionalities of the system of the present invention result analogously from corresponding technical functionalities of the method of the present invention, and vice versa.

The method is, for example, a computer-implemented method.

The system is, for example, programmatically configured to execute the computer program.

For example, the system is configured to perform all steps of the method for infrastructure-supported assistance of a motor vehicle.

The air interface is, for example, a WLAN interface or, for example, a mobile network interface. Infrastructure assistance data within the meaning of this description comprise, for example, one or more of the following data: target trajectory for the motor vehicle, object list of objects located in the vicinity of the motor vehicle, occupancy grid, which describes the occupancy of computation segments in the vicinity of the motor vehicle, etc.

Infrastructure assistance data within the meaning of the description herein comprise, for example, a request to signal, a request to change a WLAN access point, a permission to move, a command to synchronize time.

For example, bidirectional communication between the interface module and the motor vehicle is provided. For example, the interface module translates, for example, messages from the motor vehicle for the RVO system, in particular for the RVO core.

Bidirectional transmission and processing is thus provided, for example. For example, if the motor vehicle only has a proprietary air interface, the interface module can convert these proprietary messages into the standardized messages that can be processed by the RVO core.

Processing thus comprises, for example, translating such messages. The present invention is explained in more detail below using preferred exemplary embodiments.

### BRIEF DESCRIPTION OF THE DRAWINGS

FIG. 1 shows a system for infrastructure-supported assistance of a motor vehicle, according to an example embodiment of the present invention.

FIG. 2 shows a flowchart of a method for infrastructure-supported assistance of a motor vehicle, according to an example embodiment of the present invention.

FIG. 3 shows a machine-readable storage medium, according to an example embodiment of the present invention.

FIG. 4 shows another system for infrastructure-supported assistance of a motor vehicle, according to an example embodiment of the present invention.

### DETAILED DESCRIPTION OF EXAMPLE EMBODIMENTS

FIG. 1 shows a system 101 for infrastructure-supported assistance of a motor vehicle, comprising:
an RVO system 103 configured to ascertain infrastructure assistance data in order to assist the motor vehicle in an infrastructure-supported manner during at least partially automated driving,
an interface module 105,
wherein the interface module 105 has an input 107 configured to receive the ascertained infrastructure assistance data,
wherein the interface module 105 is programmatically configured to execute one or more computer programs in order to process the received infrastructure assistance data in order to obtain a processing result,
wherein the interface module 105 has an output 109 configured to output the processing result, and
an air interface 111 configured to transmit the output processing result to the motor vehicle.

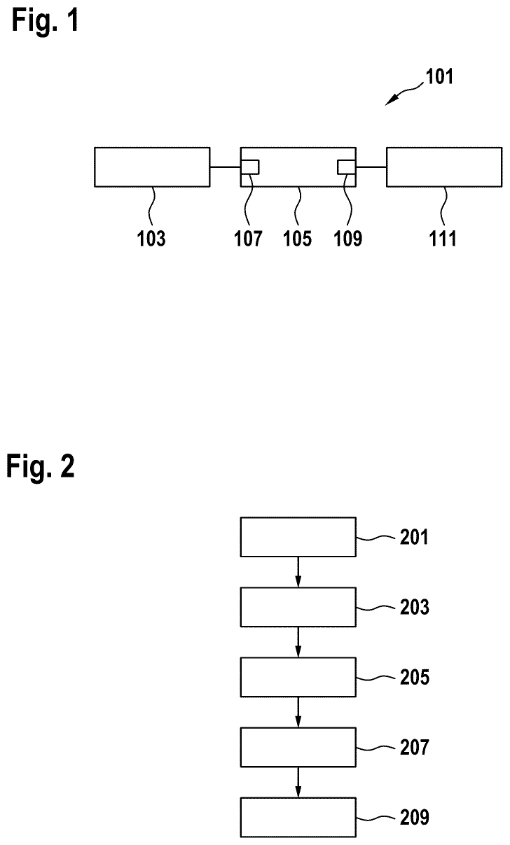

FIG. 2 shows a flowchart of a method for infrastructure-supported assistance of a motor vehicle using the system according disclosed herein, comprising the following steps:
ascertaining 201 infrastructure assistance data in order to assist the motor vehicle in an infrastructure-supported manner during at least partially automated driving, by the RVO system, receiving 203 the ascertained infrastructure assistance data through the input of the interface module,
executing 205 one or more computer programs in order to process the received infrastructure assistance data in order to obtain a processing result, by the interface module,
outputting 207 the processing result through the output of the interface module,
transmitting 209 the output processing result to the motor vehicle through the air interface.

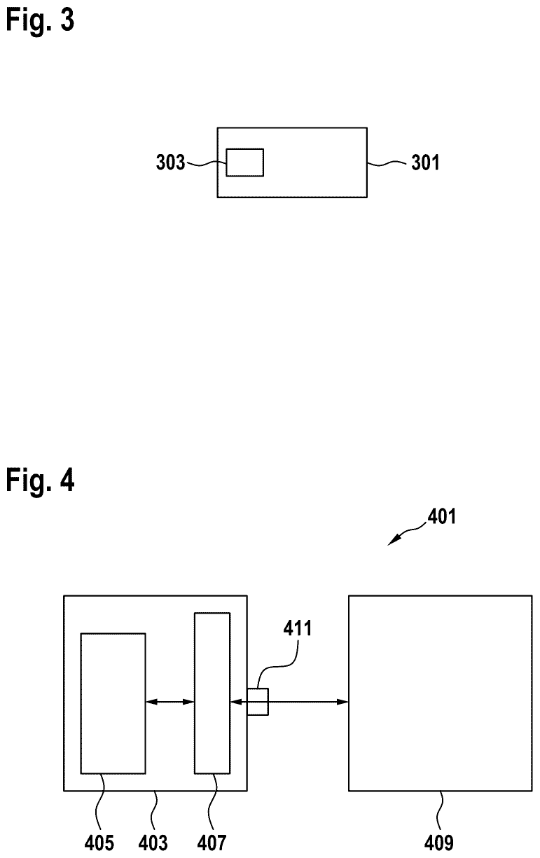

FIG. 3 shows a machine-readable storage medium 301, on which a computer program 303 is stored. The computer program 303 comprises commands that, when the computer program 303 is executed by a computer, e.g., by the system according to the first aspect, cause said computer to perform a method for infrastructure-supported assistance of a motor vehicle.

FIG. 4 shows another system 401 for infrastructure-supported assistance of a motor vehicle.

The system 401 comprises an RVO system 403 configured to ascertain infrastructure assistance data in order to assist the motor vehicle in an infrastructure-supported manner during at least partially automated driving.

The RVO system 403 comprises an RVO core 405 configured to ascertain and output the infrastructure assistance data.

The system 401 comprises an interface module 407, which is implemented within the RVO system 403.

For clarity, one input and one output of the interface module 407 are not shown in FIG. 4.

In general, it can be provided that the input is identical to the output. Thus, in particular, a combined input/output can be provided.

For example, the input and output of the interface module can thus be implemented as a common interface.

The interface module 407 receives the ascertained infrastructure assistance data via the input (not shown) and executes one or more computer programs in order to process the received infrastructure assistance data in order to obtain a processing result, for example processed infrastructure assistance data. These processed infrastructure assistance data, in general the processing result, are output through the output and transmitted to a motor vehicle 409 through an air interface 411.

It is thus possible within the interface module 407, for example, to execute computer programs from a motor vehicle OEM in order, for example, to prepare infrastructure assistance data, which are ascertained by the RVO core 403, for the motor vehicle 409 so that said motor vehicle can use the infrastructure assistance data.

In FIG. 4, double arrows are drawn between the individual elements, in particular between the interface module 407 and the motor vehicle 409 between adapter and vehicle. This means that bidirectional communication between the corresponding elements, in particular bidirectional communication between the interface module 407 and the motor vehicle 409, can be provided. In other words, the interface module 407 translates, for example, messages from the motor vehicle 409 for the RVO system, here in particular for the RVO core 405.

Bidirectional transmission and processing is thus provided, for example. For example, if the motor vehicle 409 only has a proprietary air interface, the interface module 407 can convert these proprietary messages into the standardized messages that the RVO core 405 can process.

What is claimed is:

1. A system for infrastructure-supported assistance of a motor vehicle, the system comprising:
a remote vehicle operation (RVO) system configured to ascertain infrastructure assistance data to assist the motor vehicle in an infrastructure-supported manner during at least partially automated driving;
an interface module, wherein the interface module has an input configured to receive the ascertained infrastructure assistance data, wherein the interface module is programmatically configured to execute one or more computer programs to process the received infrastructure assistance data in order to obtain a processing result, and wherein the interface module has an output configured to output a result of the processing; and
an air interface configured to transmit the output processing result to the motor vehicle.

2. The system according to claim 1, wherein the interface module is implemented within the RVO system.

3. The system according to claim 1, wherein the interface module is programmatically configured to execute a program library as a computer program.

4. The system according to claim 1, wherein the RVO system has an RVO core configured to ascertain and output the infrastructure assistance data, wherein the input of the interface module is configured to receive the infrastructure assistance data output by the RVO core.

5. The system according to claim 1, further comprising:
a communication interface configured to receive one or more computer programs from a motor vehicle original equipment manufacturer (OEM), wherein the input of the interface module is configured to receive the one or more computer programs of the motor vehicle OEM, wherein the interface module is programmatically configured to execute the one or more computer programs of the motor vehicle OEM.

6. A method for infrastructure-supported assistance of a motor vehicle, using a system including:
a remote vehicle operation (RVO) system configured to ascertain infrastructure assistance data to assist the motor vehicle in an infrastructure-supported manner during at least partially automated driving,
an interface module, wherein the interface module has an input configured to receive the ascertained infrastructure assistance data, wherein the interface module is programmatically configured to execute one or more computer programs to process the received infrastructure assistance data in order to obtain a processing result, and wherein the interface module has an output configured to output a result of the processing, and
an air interface configured to transmit the output processing result to the motor vehicle;
the method comprising the following steps:
ascertaining, by the RVO system, the infrastructure assistance data to assist the motor vehicle in an infrastructure-supported manner during at least partially automated driving;
receiving the ascertained infrastructure assistance data through the input of the interface module;
executing, by the interface module, one or more computer programs to process the received infrastructure assistance data to obtain a processing result;
outputting the processing result through the output of the interface module; and
transmitting the output processing result to the motor vehicle through the air interface.

7. A non-transitory machine-readable storage medium on which is stored a computer program for infrastructure-supported assistance of a motor vehicle, using a system including:
a remote vehicle operation (RVO) system configured to ascertain infrastructure assistance data to assist the motor vehicle in an infrastructure-supported manner during at least partially automated driving,
an interface module, wherein the interface module has an input configured to receive the ascertained infrastructure assistance data, wherein the interface module is programmatically configured to execute one or more computer programs to process the received infrastructure assistance data in order to obtain a processing result, and wherein the interface module has an output configured to output a result of the processing, and
an air interface configured to transmit the output processing result to the motor vehicle;
the computer program, when executed by computer, causing the computer to perform the following steps:
ascertaining, by the RVO system, the infrastructure assistance data to assist the motor vehicle in an infrastructure-supported manner during at least partially automated driving;
receiving the ascertained infrastructure assistance data through the input of the interface module;
executing, by the interface module, one or more computer programs to process the received infrastructure assistance data to obtain a processing result;
outputting the processing result through the output of the interface module; and
transmitting the output processing result to the motor vehicle through the air interface.
